(19) United States
(12) Patent Application Publication
(10) Pub. No.: US 2006/0285282 A1
(43) Pub. Date: Dec. 21, 2006

(54) Rear panel assembly for a computer chassis

(75) Inventor: Hsin-Hung Chen, Chung-Ho City (TW)

Correspondence Address: NIKOLAI & MERSEREAU, P.A., 900 SECOND AVENUE SOUTH, SUITE 820, MINNEAPOLIS, MN, 55402, US

(73) Assignee: Cooler Master Co., Ltd., Chung-Ho City (TW)

(21) Appl. No.: 11/156,695

(22) Filed: Jun. 20, 2005

(51) Int. Cl. G06F 1/16

(52) U.S. Cl. 361/679

(57) ABSTRACT

A rear panel assembly for a computer chassis has a mounting panel, at least one panel hinge, a terminal panel and an interface-card panel. The mounting panel has two edges and a panel opening defined through the mounting panel. The at least one panel hinge is mounted one edge of the mounting panel. The terminal panel and the interface-card panel are attached pivotally and detachably one panel hinge, and each panel has at least one latch to hold the panel in the panel opening in the mounting panel. With the terminal panel above or below the interface-card panel, the rear panel assembly has two different configurations to accommodate two types of motherboards.

### BACKGROUND OF THE INVENTION

1. Field of the Invention

The present invention relates to a panel assembly, and more particularly to a rear panel assembly mounted on a computer chassis. The rear panel assembly can be configured to be compatible with ATX and BTX motherboards.

2. Description of Related Art

A computer usually has a computer chassis that holds a motherboard, a power supply and multiple printed circuit boards (PCB) such as a graphic card, a sound card and a network card.

The motherboard mounted in the computer chassis usually has electronic components such as capacitors, slots for Random Access Memories (RAM) and a socket for a central processing unit (CPU) mounted on the motherboard. Motherboards are available in compliance with several standards such as an advanced technology extended (ATX) standard and a micro-ATX standard depending on the electronic component configuration on the motherboards. ATX motherboards are currently used with most computers and conventional computer chassis have a rear panel corresponding to the ATX and micro-ATX motherboard.

The famous chip-manufacturer, Intel Corp.®, redesigned the configuration of electronic components on a motherboard to adapt to new computer hardware and to improve the performance of the motherboard and established a balanced technology extended (BTX) standard for motherboards. The configuration of electronic components on a BTX motherboard is significantly different from an ATX motherboard. Computer hardware develops very rapidly, and BTX motherboards are becoming very popular and are replacing ATX motherboards. ATX motherboards are predictably becoming obsolescent.

However, the rear panel of a conventional computer chassis is formed integrally with the computer chassis and is incompatible with BTX motherboards. Therefore, a computer user must buy a BXT chassis when replacing an ATX motherboard with a BTX motherboard.

To overcome the shortcomings, the present invention provides a rear panel assembly for a computer chassis to mitigate or obviate the aforementioned problems.

### SUMMARY OF THE INVENTION

The main objective of the invention is to provide a rear panel assembly for a computer chassis that will accommodate either an ATX or BTX motherboard.

A rear panel assembly for a computer chassis in accordance with the present invention comprises a mounting panel, at least one panel hinge, a terminal panel and an interface-card panel.

The mounting panel has two edges and a panel opening defined through the mounting panel.

The at least one panel hinge is mounted on one edge of the mounting panel.

The terminal panel and the interface-card panel are attached pivotally and detachably to the at least one panel hinge, and each panel has at least one latch to hold the panel in the panel opening in the mounting panel.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a rear panel assembly for a computer chassis in accordance with the present invention configured to support a BTX motherboard;

FIG. 2 is an exploded perspective view of the rear panel assembly in FIG. 1;

FIG. 3 is an operational top view of the rear panel assembly in FIG. 1 with a terminal panel pivoting on a panel hinge;

FIG. 4 is an enlarged cross sectional top view of a latch on the rear panel assembly in FIG. 1;

FIG. 5 is an operational perspective view of the rear panel assembly in FIG. 1 with the terminal panel open and sliding upward;

FIG. 6 is a perspective view of the first embodiment of the rear panel assembly for a computer chassis in accordance with the present invention configured to support an ATX motherboard;

FIG. 7 is a perspective view of a second embodiment of a rear panel assembly for a computer chassis in accordance with the present invention configured to support a BTX motherboard; and

FIG. 8 is an operational perspective view of the rear panel assembly in FIG. 7 with terminal and interface-card panels open and sliding respectively up and down.

### DETAILED DESCRIPTION OF PREFERRED EMBODIMENT

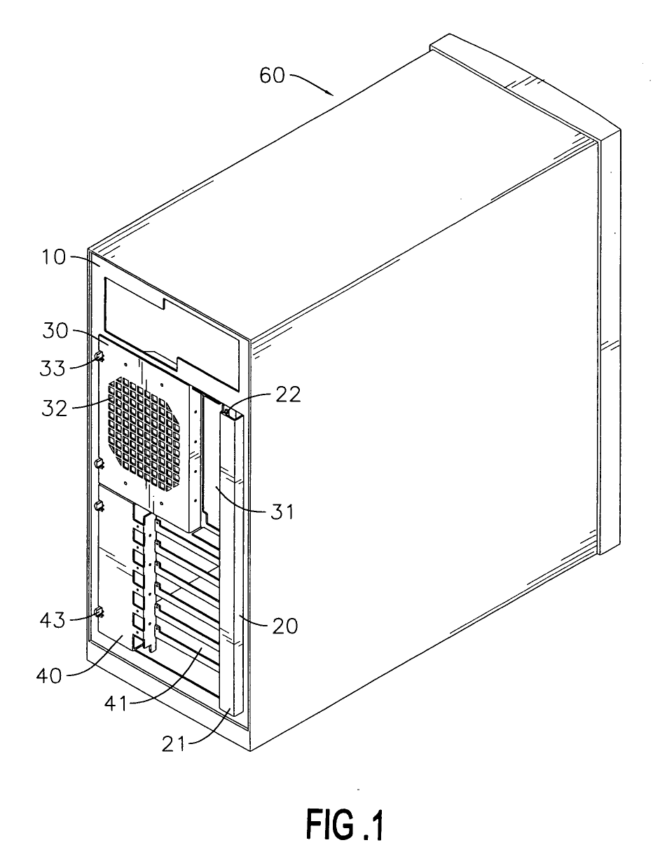

With reference to FIGS. 1, 6 and 7, a rear panel assembly in accordance with the present invention is mounted on a computer chassis (60) of a computer that has a motherboard, a power supply and multiple interface cards. The computer chassis (60) has an internal cavity, a rear and a rear opening. The rear opening is defined through the rear of the computer chassis (60). The motherboard may be an advanced technology extended (ATX) or balanced technology extended (BTX) motherboard and is mounted in the internal cavity of the computer chassis (60). The power supply and multiple interface cards are also mounted inside the internal cavity and are accessed through the rear panel assembly.

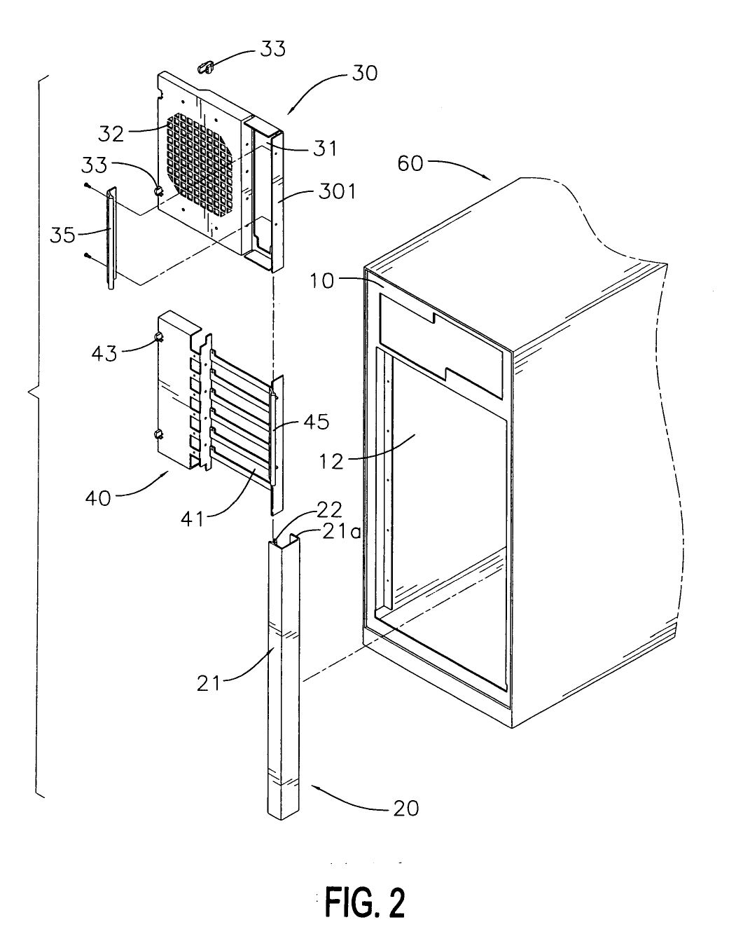

With further reference to FIG. 2, the rear panel assembly is comprises a mounting panel (10), at least one panel hinge (20), a terminal panel (30) and an interface-card panel (40).

The mounting panel (10) is mounted in the rear opening, may be welded, screwed or riveted and has two edges and a panel opening (12). The panel opening (12) is defined through the mounting panel (10) and has an inner edge.

The at least one panel hinge (20) is mounted respectively on edges of the mounting panel (10), may be U-shaped and have a cross member, an inner wing (21a), an outer wing (21) and has an engaging element (22). In a first embodiment of the rear panel assembly in accordance with the present invention, a single panel hinge (20) is mounted along one edge of the mounting panel (10). In a second embodiment of the rear panel assembly in accordance with the present invention, two panel hinges (20, 20′) are mounted respectively along the edges of the mounting panel (10). The cross member has two sides. The inner wing (21a) extends perpendicularly from one of the sides of the cross member and is attached to the edge of the mounting panel (10) with screws or rivets or by welding. The outer wing (21) extends perpendicularly from the other side of the cross member and has an inside surface facing the inner wing (21a). The engaging element (22) is formed on the at least one panel hinge (20) and may be a track (22). The track (22) is formed longitudinally on the panel hinge (20), may be formed on the inside surface of the outer wing (21) and has an open slot. The open slot is defined longitudinally in the track (22) and has a C-shaped cross-section and two open ends.

The terminal panel (30) is attached pivotally and detachably to one panel hinge (20) and has two edges, a terminal slot (31), an optional vent (32), a hinge connector (35) and at least one latch (33).

The terminal slot (31) is defined vertically through the terminal panel (30) close to one edge and allows multiple terminals such as universal serial bus ports on the motherboard in the computer chassis (60) to extend through the terminal slot (31).

The vent (32) is defined through the terminal panel (30) and is aligned with a fan in the computer chassis (60).

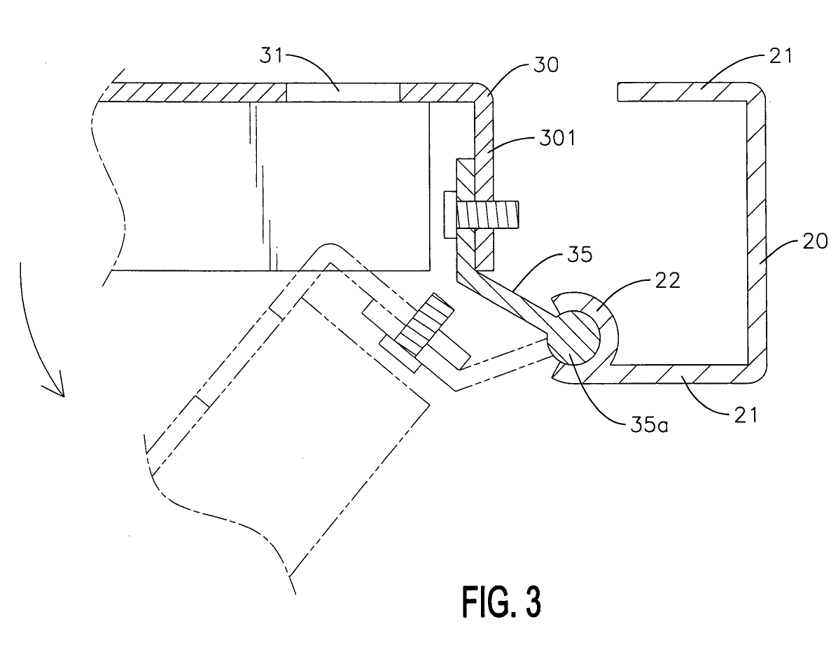

With further reference to FIG. 3, the hinge connector (35) is mounted on the edge of the terminal panel (30) close to the terminal slot (31), is attached pivotally and slidably to the track (22) on one panel hinge (20) and has an engaging element (35a). The engaging element (35a) is formed on the hinge connector (35), slidably, rotatably and detachably engages the engaging element (22) on a panel hinge (20) and may be a cylindrical pivot slide (35a). With the terminal panel (30) open, the hinge connector (35) slides up in the track (22) to detach the terminal panel (30) from the panel hinge (20).

The at least one latch (33) is mounted on the edge of the terminal panel (30) opposite to the hinge connector (35) and engages the inner edge of the panel opening (12) in the mounting panel (10) when the terminal panel (30) closes in the panel opening (12).

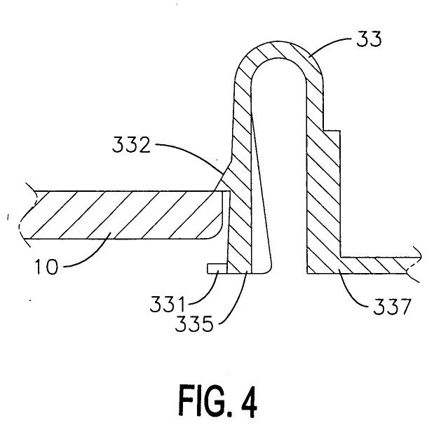

With further reference to FIG. 4, the at least one latch (33) may be a semi-rigid U-shaped clamp and have a proximal end (337), a distal end (335), a fixed segment, a resilient segment, a lip (331) and an inclined latch (332). The fixed segment is mounted to the edge of the terminal panel (30). The resilient segment is formed on the fixed segment. The lip (331) extends perpendicularly from the distal end (331) of the resilient segment. The inclined latch (332) is formed on the resilient segment at an interval from the lip (331) and has an inclined outer surface.

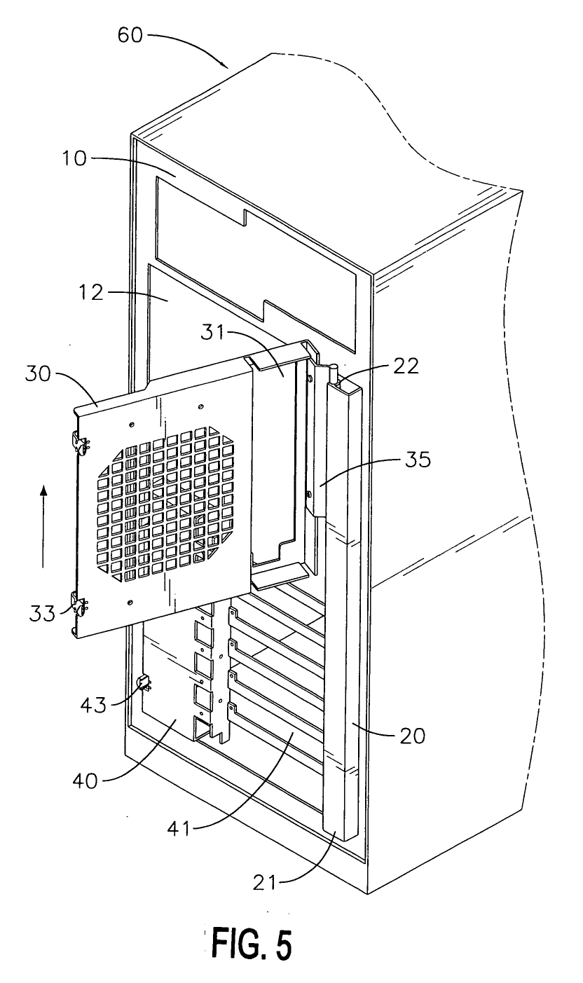

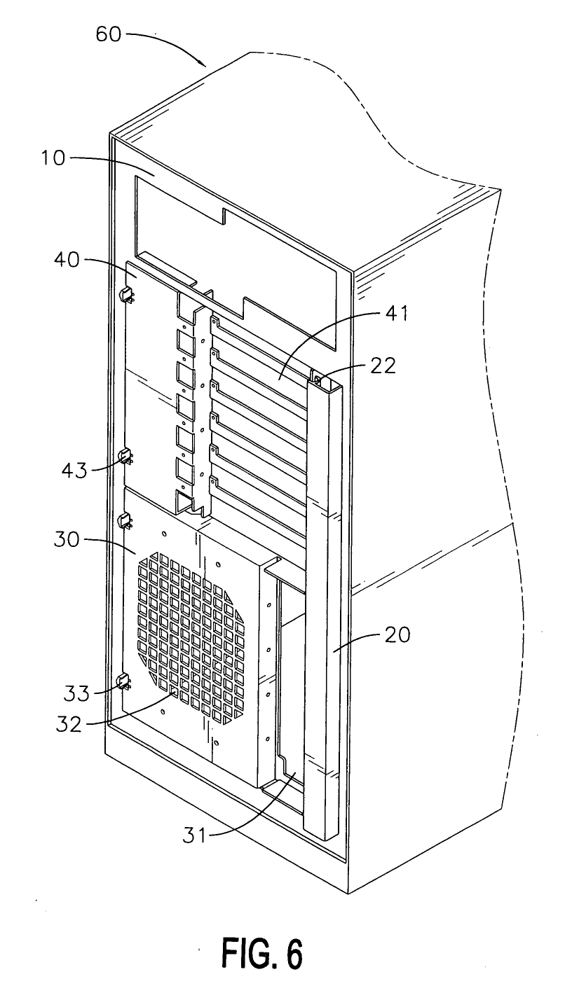

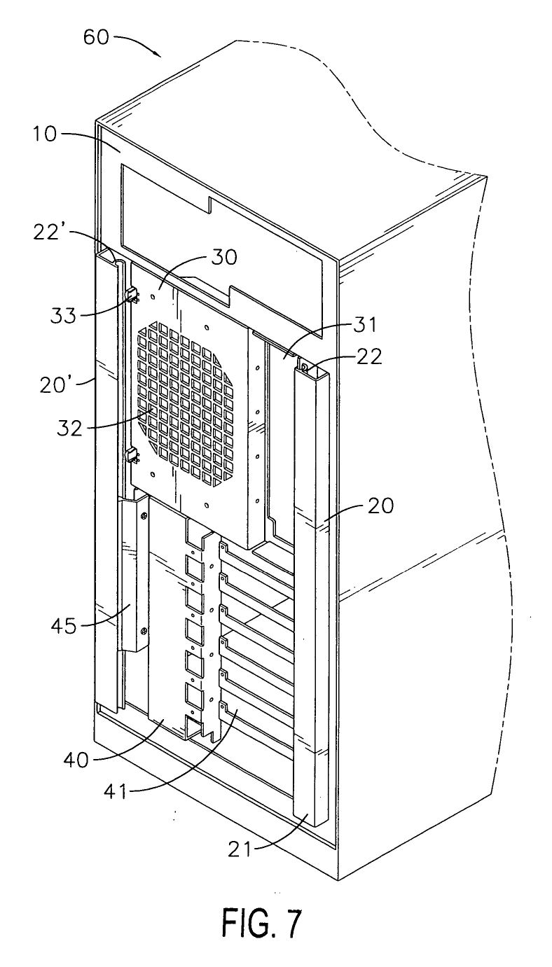

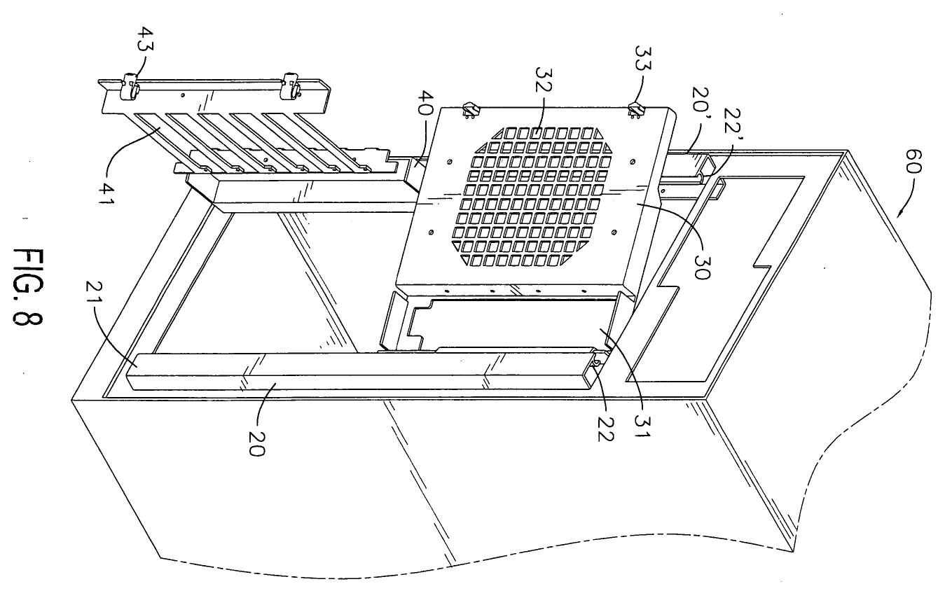

The interface-card panel (40) is attached pivotally and detachably to one panel hinge (20), is adjacent to the terminal panel (30) and has two edges, multiple card slots (41), a hinge connector (45) and at least one latch (43). With reference to FIGS. 5 and 6, a first embodiment of the rear panel assembly in accordance with the present invention has the interface-card panel (40) attached to the same panel hinge (20) as the terminal panel (30). The interface-card panel (40) may be mounted below the terminal panel (30) to accommodate a BTX motherboard or above the terminal panel (30) to accommodate an ATX motherboard. With reference to FIGS. 7 and 8, a second embodiment of the rear panel assembly in accordance with the present invention has the terminal panel (40) and the interface-card panel (30) mounted on opposite panel hinges (20). The interface-card panel (40) may be mounted below the terminal panel (30) to accommodate a BTX motherboard or above the terminal panel (30) to accommodate an ATX motherboard.

The card slots (41) are defined transversely through the interface-card panel (40) and allows terminals on the interface cards to extend through the card slots (41).

The hinge connector (45) is the same as the previously described hinge connector (35) on the terminal panel (30), is mounted to one edge of the interface-card panel (40) and is attached pivotally and slidably to the track (22) on one panel hinge (20). With the interface-card panel (40) open, the hinge connector (45) slides up in the track (22) to detach the interface-card panel (40) from the panel hinge (20).

The at least one latch (43) is mounted on the edge of the interface-card panel (40) opposite to the hinge connector (45) and has features and functions the same as those of the previously described latch (33) on the terminal panel (30). Consequently, redundant description is omitted.

The rear panel assembly as described allows a user or a manufacturer to use the same computer chassis with either a BTX or ATX motherboard, which allows a user to upgrade from an ATX motherboard to a BTX motherboard and manufacturers to reduce inventories and parts support with regard to computer chassis.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A rear panel assembly for a computer chassis comprising:
a mounting panel having
two edges; and
a panel opening defined through the mounting panel and having an inner edge;
at least one panel hinge mounted respectively on edges of the mounting panel, and each panel hinge having
an engaging element formed on the panel hinge;
a terminal panel attached pivotally and detachably to one of the at least one panel hinge and having
two edges;
a terminal slot defined vertically through the terminal panel close to one edge;
a hinge connector mounted on the edge of the terminal panel close to the terminal slot, attached pivotally and slidably to a corresponding one panel hinge and having an engaging element slidably, rotatably and detachably engaging the engaging element on the corresponding panel hinge; and
at least one latch mounted on the edge of the terminal panel opposite to the hinge connector and engaging the inner edge of the panel opening in the mounting panel when the terminal panel closes in the panel opening; and
an interface-card panel attached pivotally and detachably to one of the at least one panel hinge, being adjacent to the terminal panel and having
two edges;
multiple card slots defined transversely through the interface-card panel;
a hinge connector mounted on one edge of the interface-card panel, attached pivotally and slidably to a corresponding one panel hinge and having an engaging element slidably, rotatably and detachably engaging the engaging element of the corresponding panel hinge; and
at least one latch mounted on the edge of the terminal panel opposite to the hinge connector and engaging the inner edge of the panel opening in the mounting panel when the interface-card panel closes in the panel opening.

2. The rear panel assembly as claimed in claim 1, wherein:
the at least one panel hinge is a single panel hinge mounted along one edge of the mounting panel; and
the terminal panel and interface-card panel are attached to the single panel hinge.

3. The rear panel assembly as claimed in claim 1, wherein:
the at least one panel hinge are two panel hinges mounted respectively on the edges of the mounting panel;
the terminal panel is attached to one panel hinge; and
the interface panel is attached to the other panel hinge.

4. The rear panel assembly as claimed in claim 2, wherein:
the engaging element of the single panel hinge is a track formed longitudinally on the panel hinge and having an open slot defined longitudinally in the track and having two open ends; and
the engaging element of each hinge connector of the terminal panel and the interface-card panel is a pivot slide formed on the hinge connector and mounted slidably, rotatably and detachably in the open slot in the track of the single panel hinge.

5. The rear panel assembly as claimed in claim 4, wherein the open slot in the track on the panel hinge has a C-shaped cross section and the pivot slide of each hinge connector is cylindrical.

6. The rear panel assembly as claimed in claim 4, wherein:
the single panel hinge is U-shaped and has
a cross member having two sides;
an inner wing extending perpendicularly from one of the sides of the cross member and attached to the edge of the mounting panel; and
an outer wing extending perpendicularly from the other side of the cross member and has an inside surface facing the inner wing; and
the engaging element on the panel hinge is formed on the inside surface of the outer wing.

7. The rear panel assembly as claimed in claim 6, wherein each one of the at least one latch on the terminal panel is a semi-rigid U-shaped clamp and has
a proximal end;
a distal end;
a fixed segment attached to the edge of the terminal panel;
a resilient segment formed on the fixed segment;
a lip extending perpendicularly from the resilient segment at the distal end; and
an inclined latch formed on the resilient segment at an interval from the lip and having an inclined outer surface.

8. The rear panel assembly as claimed in claim 7, wherein each one of the at least one latch on the interface-card panel is a semi-rigid U-shaped clamp and has
a proximal end;
a distal end;
a fixed segment attached to the edge of the interface-card panel;
a resilient segment formed on the fixed segment;
a lip extending perpendicularly from the resilient segment at the distal end; and
an inclined latch formed on the resilient segment at an interval from the lip and having an inclined outer surface.

9. The rear panel assembly as claimed in claim 1, wherein the terminal panel further has a vent defined through the terminal panel.

10. The rear panel assembly as claimed in claim 3, wherein:
the engaging element of each panel hinge is a track formed longitudinally on the panel hinge and having an open slot defined longitudinally in the track and having two open ends; and
the engaging element of each hinge connector of the terminal panel and the interface-card panel is a pivot slide formed on the hinge connector and mounted slidably, rotatably and detachably in the open slot in the track of a corresponding one panel hinge.

11. The rear panel assembly as claimed in claim 10, wherein the open slot in the track on each panel hinge has a C-shaped cross section and the pivot slide of each hinge connector is cylindrical.

12. The rear panel assembly as claimed in claim 10, wherein:
each panel hinge is U-shaped and has
a cross member having two sides;
an inner wing extending perpendicularly from one of the sides of the cross member and attached to the edge of the mounting panel; and
an outer wing extending perpendicularly from the other side of the cross member and has an inside surface facing the inner wing; and
the engaging element on each panel hinge is formed on the inside surface of the outer wing.

13. The rear panel assembly as claimed in claim 12, wherein each one of the at least one latch on the terminal panel is a semi-rigid U-shaped clamp and has
a proximal end;
a distal end;
a fixed segment attached to the edge of the terminal panel;
a resilient segment formed on the fixed segment;
a lip extending perpendicularly from the resilient segment at the distal end; and
an inclined latch formed on the resilient segment at an interval from the lip and having an inclined outer surface.

14. The rear panel assembly as claimed in claim 13, wherein each one of the at least one latch on the interface-card panel is a semi-rigid U-shaped clamp and has
a proximal end;
a distal end;
a fixed segment attached to the edge of the interface-card panel;
a resilient segment formed on the fixed segment;
a lip extending perpendicularly from the resilient segment at the distal end; and
an inclined latch formed on the resilient segment at an interval from the lip and having an inclined outer surface.

15. The rear panel assembly as claimed in claim 14, wherein the terminal panel further has a vent defined through the terminal panel.
